(19) United States
(12) Patent Application Publication
(10) Pub. No.: US 2014/0149180 A1
(43) Pub. Date: May 29, 2014

(54) SALE PREDICTION ENGINE RULES

(71) Applicant: Oracle International Corporation, (US)

(72) Inventors: Rahim Mohamed YASEEN, Redwood City, CA (US); Hetal J. SHAH, Acton, MA (US); Manish BHATIA, Bangalore (IN); Murali K. MAKKENA, Westford, MA (US); Klaus Peter GROSS, Sewickley, PA (US)

(73) Assignee: Oracle International Corporation, Redwood Shores, CA (US)

(21) Appl. No.: 13/866,946

(22) Filed: Apr. 19, 2013

Related U.S. Application Data
(60) Provisional application No. 61/635,801, filed on Apr. 19, 2012.
(60) Provisional application No. 61/786,611, filed on Mar. 15, 2013.

(51) Int. Cl. G06Q 30/02

(52) U.S. Cl. CPC G06Q 30/0202
USPC 705/7.31

(57) ABSTRACT

Disclosed is an improved method, system, and computer product for implementing a rules engine to be used in conjunction with a sale prediction engine. A rules dictionary may be used to define a logical data model for one or more rules. Predictions may be generated by applying the rules to attributes extracted from customer entities.

### CROSS-REFERENCE TO RELATED APPLICATIONS

The present application claims the benefit of priority to U.S. Provisional Patent Application Ser. No. 61/635,801, entitled “Sales Prediction Engine Rules” (Attorney Docket No. ORA121125-US-PSP), filed Apr. 19, 2012, and U.S. Provisional Patent Application Ser. No. 61/786,611, entitled “Sales Prediction Engine Rules” (Attorney Docket No. ORA121125-US-PSP-1), filed Mar. 15, 2013, which are hereby incorporated by reference in their entireties.

### BACKGROUND

Improving the productivity of a sales force is a challenge. By identifying patterns of sales successes and failures, sales representatives can work to replicate or avoid similar efforts and thereby avoid wasting cycles of cold-calling and uneventful sales activities. Sales patterns can be observed and identified. These patterns offer a window into future buying behavior.

But sales patterns are not readily identifiable to the sale and marketing organization, and therefore it is difficult for the organization to take action to improve sales success. Typical multidimensional analysis of the various factors impacting purchasing by industry, geography, customer size, install base, and the like are often too time-consuming for the sales and marketing groups to undertake.

An improved method and mechanism to perform sales prediction was described in U.S. patent application Ser. No. 13/236,629, entitled “Sales Prediction and Recommendation System”, filed on Sep. 19, 2011, which is hereby incorporated by reference in its entirety.

### SUMMARY

Disclosed is an improved method, system, and computer product for implementing a rules engine to be used in conjunction with a sale prediction engine. One or more rules are stored in a rules dictionary, wherein the rules dictionary defines a logical data model for the rules. Attributes are then extracted from entities, such as customer entities or asset entities. Predictions are generated by applying the one or more rules to the one or more extracted attributes. In some embodiments, recommendations may be generated by applying the one or more rules to the one or more extracted attributes.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

FIG. 1 illustrates an architecture of a system for rules-based leads generation according to some embodiments of the invention.

FIGS. 2A-D illustrate examples of a rules editor in accordance with embodiments of the invention.

FIGS. 3A-B illustrate a system for rules-based leads generation accordance with some embodiments of the invention.

FIG. 4 illustrates a flowchart for a process implementing rules-based lead generation.

FIGS. 5A-B illustrate a system and flowchart for implementing model-based lead generation in accordance with some embodiments of the invention.

FIGS. 6A-B illustrate a system and flowchart for implementing rule-based lead generation in accordance with some embodiments of the invention.

FIGS. 7A-B illustrate systems for implementing model-based and rule-based simulation accordance with some embodiments of the invention.

FIG. 8 illustrates a computerized system on which an embodiment of the invention can be implemented.

### DETAILED DESCRIPTION

Various embodiments are described hereinafter with reference to the figures. It should be noted that the figures are not drawn to scale and that the elements of similar structures or functions are represented by like reference numerals throughout the figures. It should be noted that the figures are only intended to facilitate the description of the embodiments. They are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments.

The present disclosure provides a rules mechanism for use in conjunction with a sales prediction engine (SPE), such as the sales prediction mechanism described in U.S. patent application Ser. No. 13/236,629, entitled “Sales Prediction and Recommendation System”, filed on Sep. 19, 2011, which is hereby incorporated by reference in its entirety.

The aforementioned Sales Prediction Engine (SPE) uses historical data and data analysis techniques such as clustering and linear regression to compute predictions. Such predictions are derived from the data and can be formally represented as derived rules.

The rules mechanism is an independent but complementary technique that allows a domain expert to specify prediction rules as heuristic inputs into the system based on the expert knowledge of such domain experts. This is especially useful in systems where there is not yet enough historical data for which a model can be generated.

It is also proposed that these two mechanisms can be coupled so that the rules that are derived from data analysis can be compared with the rules that are formulated by a domain expert and that a what-if feedback analysis can be constructed that compares the two techniques and complements the expert knowledge of the domain expert with additional insight from the data analysis.

In some embodiments, disclosed is a rules engine that will not suffer the performance degradation as the number of rules increases. The current approach supports chaining and thus allows for a very powerful rule bases. In addition, the present approach provides a business rule authoring environment and support a software development kit (SDK) that allows for the creation of custom user interfaces. Since programmatic access is provided to a rule-base, objects and attributes that are dynamically added to the rule engine can be integrated into the data model for the rule-base. In some embodiments, an example rules engine that may be implanted in conjunction with the sales prediction engine is the Oracle Business Rules (OBR) product, available from Oracle Corporation of Redwood Shores, Calif., USA.

Rather than storing rules in an internal representation that is not amenable to indexing or building custom interfaces, the approach taken in this design is to define a logical model that is grounded in a physical implementation and that can be expressed in multiple languages. Rules, which are expressed in the logical model, are transformed into the rules engine rules and executed in a runtime execution environment that understands how the logical model is tied to the physical implementation.

This yields a flexible architecture that can be leveraged to build custom user interfaces for prediction rules and recommendation eligibility conditions. Furthermore, it builds the foundation that can be leveraged to target other rule engines, such as for complex event processing and even define triggers that be used to initiate rule execution.

Some embodiments of the present approach provide for advanced rule authoring capability. In some embodiments, rule authoring may be tailored to the specification of the predictive algorithm being used. Rule authoring capabilities allow for a sales prediction engine to embody expert knowledge by a business or sales analyst as a complement to rules derived algorithmically from data analysis. This may be useful in situations where there is insufficient data to derive rules algorithmically, such as during new product launches or emerging market penetration. In some embodiments, the authored rules may also be used to augment the algorithmically derived rules.

Some embodiments allow for rules to be managed and executed in groups. In some embodiments, groups of rules may be specified as being active, effective, or expired. Some embodiments allow rules to be executed in different environments, or for multiple users to be able to create and/or edit rules at the same time.

In some embodiments, rules may be searched for based on a variety of different criteria. These criteria may include rules that were created or modified by a specific user or users, rules created or modified since a specific date, rules that refer to a specific property (e.g., industry, location, etc.), rules that refer to a specific value of a property (e.g., industry code=“1900,” location=“North America,” etc.), or rules that recommend a specific product or product family.

Some embodiments will allow for minimizing rules that do not make sense where possible. For example, in some embodiments the industry code for a customer may be expressed as a numeral (e.g. industry code of ABC customer is 1900, where the code 1900 may correspond to “High Tech”). It would not make sense for a rule to test that a customer's industry code <1900, since industry code is not orderable, despite the underlying data type being able to support such a test.

In some embodiments, list of values (LOVs) that are grounded in SQL queries may be associated with a property for use in a presentation layer. For example, a country code may be associated with a country name, or an industry code associated with an industry name (e.g., industry code 1900 associated with “High Tech”).

In some embodiments, the UI for the sales prediction engine allows for the selecting of specific instances of an entity (e.g., a specific customer or asset), in addition to specializing or constraining the entity (e.g., only generate predictions for North American customers).

In some embodiments, the sales prediction engine may be able to know and display a source of a generated recommendation. The sales prediction engine may also be able to generate explanations for a rule.

### System Architecture

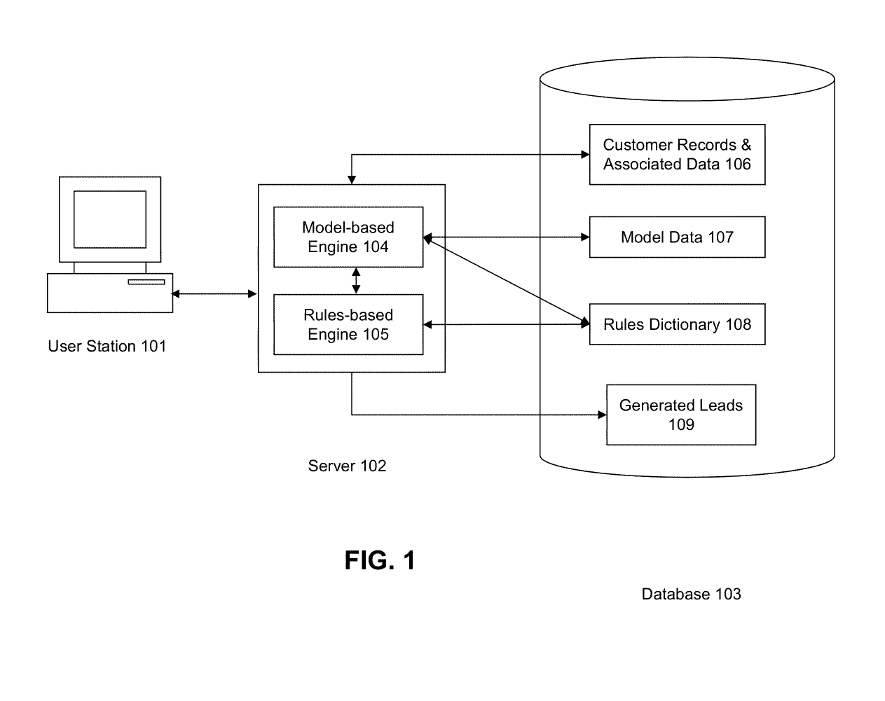

FIG. 1 illustrates an architecture of a system for implementing a rules-based sales prediction engine according to some embodiments of the invention, which may be used to generate sales predictions. In some embodiments, the sales prediction engine may also be used to generate recommendations. Users may operate the system at user station 101 to access the sales prediction engine on a server 102, which may include a rules-based engine 105 and a model-based engine 104. The information used by the sales prediction engine for defining rules, training models, and generating leads is stored in database 103, which may include customer records, lead, and revenue data 106, model data 107, rules dictionary 108. The sales prediction engine is used by the user to create generated leads 109, which may comprise predictions and/or recommendations.

As described in more detail below, the users will use the sales prediction engine to generate and define rules for a rules dictionary 108. Rules-based engine 105 accesses rules dictionary 108 in order to generate leads 109 from customer, lead, and revenue data 106. Model-based engine 104 may access both the rules dictionary 108 and model data 107 to generate leads 109 from customer, lead, and revenue data 106. For example, model-based engine 104 may use model data 107 with customer, lead, and revenue data 106 to generate leads which are then filtered using eligibility rules from rules dictionary 107 to create a final set of generated leads 109.

The user station 101 comprises any type of computing station that may be used to operate or interface with the sales prediction engine on server 102. Examples of such user stations include for example, workstations, personal computers, laptop computers, or remote computing terminals. The user station 101 may comprise a display device, such as a display monitor or screen, for displaying interface elements and report data to the user. The user station 101 may also comprise one or more input devices for the user to provide operational control over the activities of the system, such as a mouse, touch screen, keypad, or keyboard. The users of the user station 101 correspond to any individual, organization, or other entity that uses system to access the sales prediction engine on server 102.

The database 103 corresponds to any type of computer readable mediums or storage devices. The computer readable storage devices comprise any combination of hardware and software that allows for ready access to the data within the database. For example, the computer readable storage device could be implemented as computer memory or disk drives operatively managed by an operating system.

In the embodiments described below, the sales prediction engine generates predictions that may be used to create recommendations. Recommendations may be used by sales personnel to help determine which products to attempt to sell to which customers. In some embodiments, predictions may also be used in a variety of other ways. For example, predictions generated for various sales representatives in a particular territory can provide a good indication of the territory's potential. The sales prediction engine may generate a summary of the potential revenue associated with the top sales leads identified in a territory, which a territory planner may use to modify territory dimensions to balance the numbers of accounts, opportunities, leads, estimated revenue, and sales representatives. In some cases, predictions may also be used by sales analysts to determine inventory, pricing, personnel assignments, etc. for products in response to a predicted demand.

### Data Model

Embodiments of the invention may be applied for different types of data models. In some embodiments, a logical data model is used. However, in some circumstances, it may be advantageous to dispense with the logical model and rely directly on the rules engine's dictionary, which can store both the data model and the rules. The SPE would pre-define a model in the rules engine. If the system leverages the editor provided by the rules engine by embedding the rules composer (e.g., in an application development framework page (such as the Oracle ADF product)), then only the runtime execution is to be considered. However, if the rules editor is a general purpose editor, then it may not be geared towards the specific needs for a prediction or recommendation eligibility rule.

Consider, for example, the following prediction rule:
If a customer's industry is High Technology or Retail, then recommend Oracle Database Enterprise to a customer with likelihood of 56%, with an estimated sales cycle of 30 days, and with an expected revenue of $10,000.

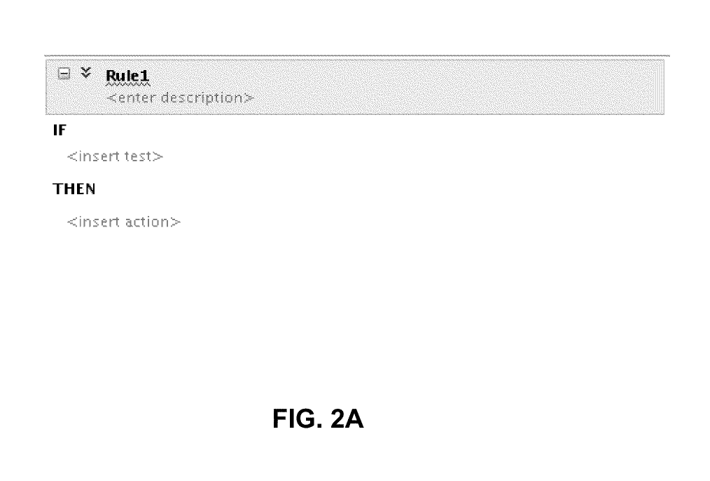

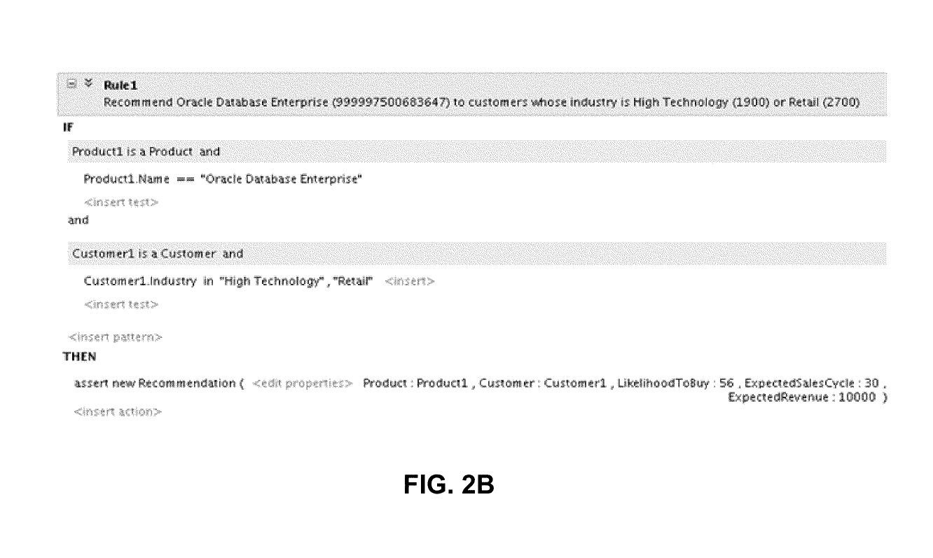

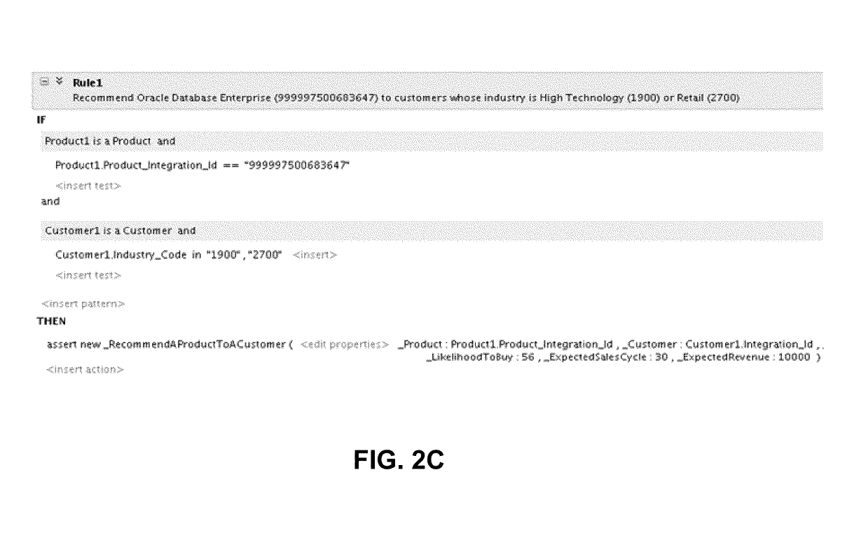

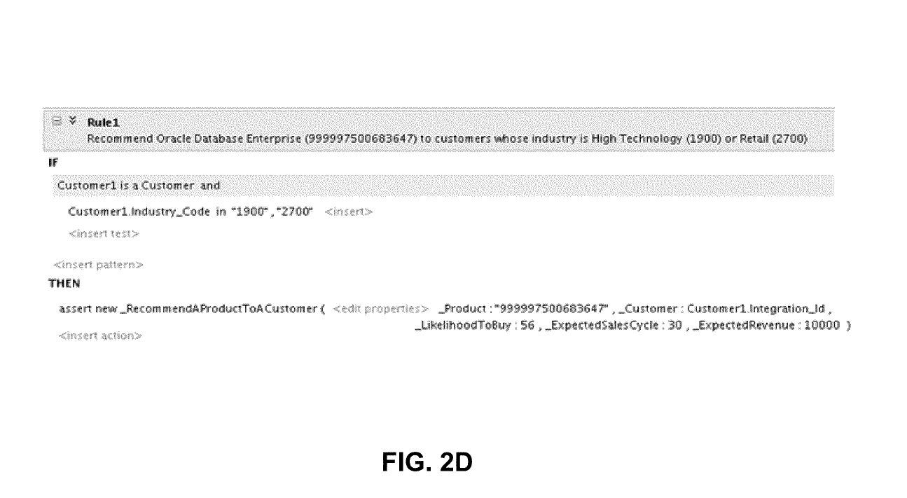

When a sales analyst decides to create a new prediction rule, the generalized rule editor may present the new rule as illustrated in FIG. 2A. FIG. 2A illustrates an example of a general purpose editor that expresses rules as simple “if-then” statements. From this starting point, the sales analyst may use the rule editor to create the above target rule, as illustrated in FIG. 2B.

First, this is clearly a daunting task with many possibilities for writing a rule that is erroneous or even worse harmful. Second, from a localization perspective, the editor is able to map a product name and an industry name to a product identifier and an industry code. The rules engine has the notion of a bucket-set, which it can use for that, but it is unclear whether or not bucket-sets can be localized. Third, if the system wants to track where recommendations came from, an additional attribute would be added to the recommendation that specified the rule id. In a general purpose rule editor, the sales analyst would have to correctly set the attribute. To avoid the aforementioned problems, a custom rule editor is employed in some embodiments.

Use of a logical model may use translation to an executable format in some cases. There are many advantages to this approach. First, the use of a logical model that is translated to an execution model decouples the system from the rules engine. Any change in the rules engine's representation requires a code change in the translator (or code generator) rather than migration of existing rules. In general, code changes to deal with representation changes are easier (and less risky) than migrating the actual data. The decoupling not only eases migration to new versions, but it also allows for targeting different execution environments in the future, such as a complex event processing environment.

In addition to the benefits of decoupling, use of a logical layer can abstract away from implementation and reduce the code necessary to translate between the presentation layer and the storage layer. Use of a code generator can also yield efficiency advantages by compiling away unnecessary patterns. Finally, a logical layer provides the means to index rules in a variety of different ways. Consider, for example, the requirement to find all of the rules that refer to a customer's industry. Finding such rules in the rules engine rules would involve significant processing, whereas finding such rules in a logical model could be as straightforward as a simple query to the database.

Therefore, in some embodiments of the invention, a logical model is used to store rules.

For rules, customization may cover two areas: extensibility and localization. An organization might want to extend the logical model and define how that logical model is expressed in a particular locale. An individual might want to customize the presentation layer for the logical model.

With respect to localization considerations, view objects can leverage resource bundles to provide labels for the view object and its columns. The locale of the user can be leveraged to load in an appropriate resource bundle. When customizations are enabled, a user can override the labels for a view object. If possible, the system should leverage these customizations.

With respect to extensibility, the logical model should be extensible to allow customization and extensibility of view objects.

The approach determines how Customer, Lead, and Revenue tables should be extended and to retrieve values for the extended columns directly via access through the data source (such as business intelligence (BI) data sources). In addition, a label API will be used which is being provided by the extensibility mechanism to obtain the display string for each of the extended attributes.

With regard to how data is obtained, the logical data model can be grounded in one or more data sources or in a set of view objects. In order to extend the data model, the new artifact is defined in the logical data model, mapped to a physical implementation, and expressed in a language.

There are several advantages to grounding the logical data model in view objects. First, security can be enforced at the view object level. Second, the presentation layer for the view object (VO), e.g., a BI VO, can be customized. Third, a VO can define transient fields that can be computed on demand. Transient fields can, for example, be used to populate a column in the Customer VO with a list of product identifiers that the customer owns.

In some embodiments, it is possible to allow implementation in view objects or in database tables directly. In other embodiments, the system according to some embodiments uses a combination of ADF View Objects and BI view objects to retrieve data from either database or BI Server and use Rule Language (RL) Facts for any deductions.

The rules engine can be used in several ways to integrate business rule processing into an application, e.g., in a service-oriented architecture (SOA) or as a Java library. The rules engine can also provide a Java library (Rules SDK) for managing business rules. The Rules Designer uses this SDK to create, modify, and access rules as well as the data model using well-defined interfaces. The SDK can also be used to define customized interfaces to manipulate both the rules and the data model.

The rules engine can provide a variety of ways to tightly integrate a rule base into an application. The objects that are evaluated by the engine can come from XML, Java objects, ADF Business Components, or can be directly defined at the Rule Language (RL) level.

In order to use XML, the customer data relevant to whitespace analysis is extracted from the database and expressed as XML.

In order to use Java objects, the customer data relevant to whitespace analysis is extracted from the database and turned into Java objects.

### Rule Transformation

Integrating at the RL level allows for code generation to transform the rule in order to improve performance. For example, the product pattern in the left-hand side (LHS) of the rule can be eliminated if the primary keys of entities are stored in the RL facts rather than pointing to fact instances. The previous recommendation rule might be expressed as illustrated in FIG. 2C using an RL representation.

This rule could be simplified without changing the semantics of the rule, as illustrated in FIG. 2D. The transformation makes the rule much more efficient because it eliminates a pattern from the left-hand side, but, more importantly, the transformation removes the need to assert any product facts into the rule engine in order to evaluate the rules.

Note that the transformation is not used if the transformed rule is stored directly. Since the initial version only allows for specifying specific products, the transformed rule will be stored.

### Lazy Loading

Code generation can also exploit the RL integration by generating rules that trigger lazy loading of related information. Consider, for example, the following recommendation rule:
If the customer's industry is in High Technology or Consumer Goods and the customer owns an asset and the asset was purchased within the last 6 months and the product for the asset is Oracle Enterprise then recommend Maintenance Contract for the customer with a likelihood to buy of 80%, an expected revenue of $10,000, and an expected sales cycle of 30 days.

In order to evaluate this rule, the demographic data about a customer would be used. However, the asset data would only be used for a customer if the customer's industry was High Technology or Consumer Goods. The code generate could generate an additional rule to trigger lazy loading as follows:
If the customer's industry is in High Technology or Consumer Goods then retrieve the assets for the customer.

Since the patterns in the left-hand side of this rule are a subset of the patterns for the original rule, the rules engine rule engine will incur very little overhead when this rule is added to the system.

Given the aforementioned considerations, the system according to some embodiments will integrate with the rules engine at the RL level.

### Data Model Design

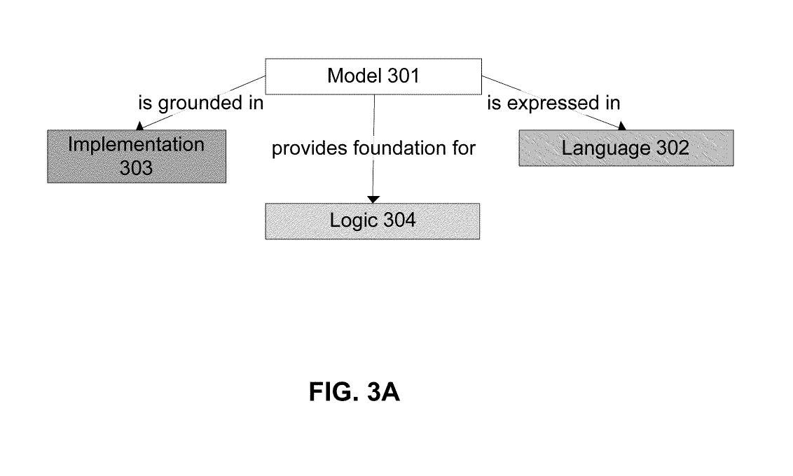

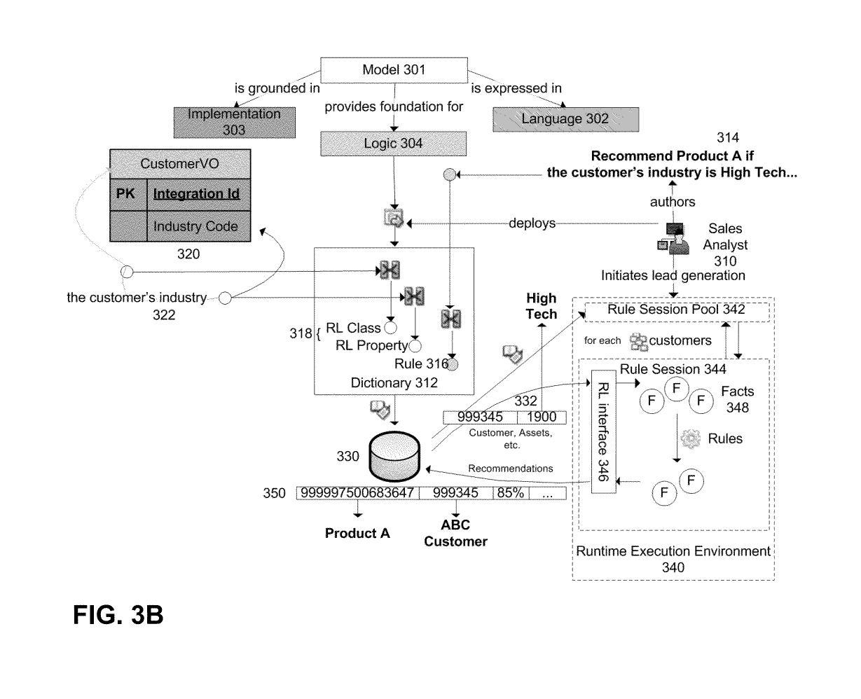

The data model that supports the custom rule editors may be conceptually broken down into several parts, comprising the model layer, the language layer, the logic layer, and the implementation layer as shown in FIG. 3A.

The model layer 301 provides the foundation for the other layers and comprises entities, roles, functions, and actions. The model provides the database schema in which the rules are stored.

The language layer 302 is used during presentation. Each item in the model layer 301 may be tied to a “phrasings” in a particular language in the language layer. For example, rules in a rules dictionary may be expressed in a RL (Rules Language) such as Oracle Business Rules (OBR) Language.

The implementation layer 304 provides the grounding for the model layer 301 and is used during code generation and execution. Entities may be tied to view objects. Functions are implemented as procedural code. Relations and properties may be tied to columns in a view object.

The logic layer 304 is used to capture the semantics (or logic) of rules, which is tied to specific constructs in the model layer 301. The logic layer 304 contains folders, rules, and bindings.

In this design in some embodiments, the distinctions are not kept in separate tables, but rather are mixed together. To simplify the diagrams, the standard record history columns for a table are omitted from the table diagrams. All columns corresponding to identifiers will be populated as application unique identifiers.

### Overall Design

A logical data model is provided that is grounded in a physical implementation. The logical data model can be expressed in a particular language. Rules are stored as logical formulas. Sales Analysts author rules as a logical formula, which can be deployed. Deployment transforms rules expressed as logical formulas into a dictionary by understanding how the logical data model is mapped to constructs in the rule language. Lead generation (and simulation), which are initiated by a Sales Analyst, loads the dictionary and processes each customer in its own rule session.

FIG. 3B illustrates a system in accordance with embodiments of the invention. A user (such as a sales analyst) at 310 uses the system to deploy a rules dictionary 312. The rules dictionary 312 stores the data models for the rules as well as the actual rules themselves. Rules dictionary 312 may contain multiple rules, each having multiple attributes.

In some embodiments, the system may support a custom rule editor, reducing the risk of a user writing a rule that can break the system, and also because a custom rule editor can be more intuitive to the end user. The custom rule editor may support a tabular set of conditions on the customer entity that can be “ANDed” or “ORed” together (e.g., “if customer industry is high tech AND is located in Asia, then recommend product A”). The custom rule editor may also support multiple target products in one rule (e.g., “if customer meets certain attributes, recommend Product A and Product B”).

The custom rule editor may also support both recommendation rules and eligibility conditions. Recommendation rules recommend products to customers whose attributes meet certain conditions (e.g., recommend product A to customer whose industry is “High Tech”). On the other hand, eligibility conditions bar customers with certain attributes from being recommended a certain product, even if the model or other rules would recommend the product (e.g., do not recommend product A to customer with number of employees less than 50). The system leverages a common task flow across the custom rule editors for adding conditions since that is the common part of all of the rules.

User 310 authors new rules 314 using a user interface provided by the system. For example, user 310 may author a new rule that recommends Product A if the industry of a customer is High Tech. The authored rule 314 is stored in the rules dictionary 312, which maps the logical formula entered by the user to RL constructs, as rule 316. Rules may be defined based on customer data or asset data. Asset data comprises information on entities representing products a customer already owns. For example, the user 310 may wish to make use of asset data by defining a new rule that recommends Product A only to customers who already own Product B.

Rules dictionary 312 contains RL classes and RL properties 318. The RL class holds the logic for a particular rule, and accesses data from a customer VO 320. The RL properties define the attributes for a rule. For example, a rule that checks if a customer has annual revenue of greater than $5 million will have a left-hand side with three properties: “annual revenue,” “greater than,” and “$5 million.” Rules dictionary 312 maps the properties of rule 316 with attributes 322 extracted from customer VO 320. For example, rule 316 may contain an “customer industry” attribute that is mapped by rules dictionary 312 to an “industry” attribute from customer VO 320.

Customer VO 320 is a logical representation of the physical schema of the customer data, and may be populated when customer data stored in the schema is read, such as by running a query on the customer table. Since the VOs represent the physical Customer table, each VO 320 has a primary key (PK) that is an integration ID. The integration ID is the view object level for read-only data, such as customer, asset, lead, etc. Integration is at the RL level for all deductions.

In some embodiments, each customer VO 320 maps to one customer row in the database. Rules dictionary 312 accesses customer VO 320 in order to determine the values of the properties specified in the rules. For example, rule 316 in FIG. 3B contains the property that the customer's industry is high tech. Rules dictionary 312 may access customer VO 320 to determine that high tech corresponds to the industry code of 1900.

The system leverages a logical model. A logical model simplifies coding, insulating the system from changes to how the rules engine stores rules. A logical model allows for the targeting of other execution environments, such as Oracle Complex Event Processing (CEP).

The logical model is implemented in view objects and view links. View objects avoid potential security issues when implementing directly at the language level, allow the hiding of 1-1 relations from the end user, and make the properties of the destination directly available to the source. For example, if a “sales account” attribute is added as an extended attribute, the sales account extension columns can be made directly accessible as properties of a customer rather than requiring the end user to traverse the relation from customer to the sales account extension. View objects allow for the defining of aggregate columns that cannot be defined in the repository definition (e.g., the list of products that a customer owns), and the defining of lists of values directly in the view object rather than requiring inventing our own mechanism.

Rule dictionary 312 may be stored in database 330. Database 330 may be a single database, or a plurality of databases. Database 330 may also contain the customer and asset data from which customer VO 320 is derived. In some embodiments, database 330 may be a sales database or a marketing database.

Once rules dictionary 312 has been populated with generated rules 316, the user 310 may initiate lead generation at the runtime execution environment 340. Lead generation is a batch process that can generate all the products that can be recommended for a set of customers. Runtime execution environment 340 takes as inputs from database 330 the generated rules in rule dictionary 312 and a set of customer or asset data 332. For example, FIG. 3B illustrates rule session 344 receiving through RL interface 346 customer data for customer 999345, corresponding to “ABC Customer.” The customer has an industry code of 1900, which corresponds to “High Tech.”

When lead generation is initiated, a rule session pool 342 is formed using the rules from the rules dictionary 312. The rule session pool 342 contains all the rules that the user wishes to use for lead generation. For each customer or asset to be analyzed, runtime execution environment 340 creates a rule session 344. Each rule session 344 may contain a RL interface API 346 through which the rule session receives the customer or asset data.

The rule session 344 is initialized with customer information, such as customer demographic information, the customer's assets, etc., and the rules are executed. Rules session 344 extracts one or more facts 348 from each customer (e.g., the customer's industry code), and applies the rules to the extracted facts. The rules yield recommendations 350 which are persisted to the database. For example, FIG. 3B illustrates that Product A may be recommended to ABC Customer with a confidence level of 85%. In addition to product name, customer name, and confidence level, the recommendation may also include additional information, such as predicted length of the sales cycle to convert the lead into an order, or the predicted revenue from the lead.

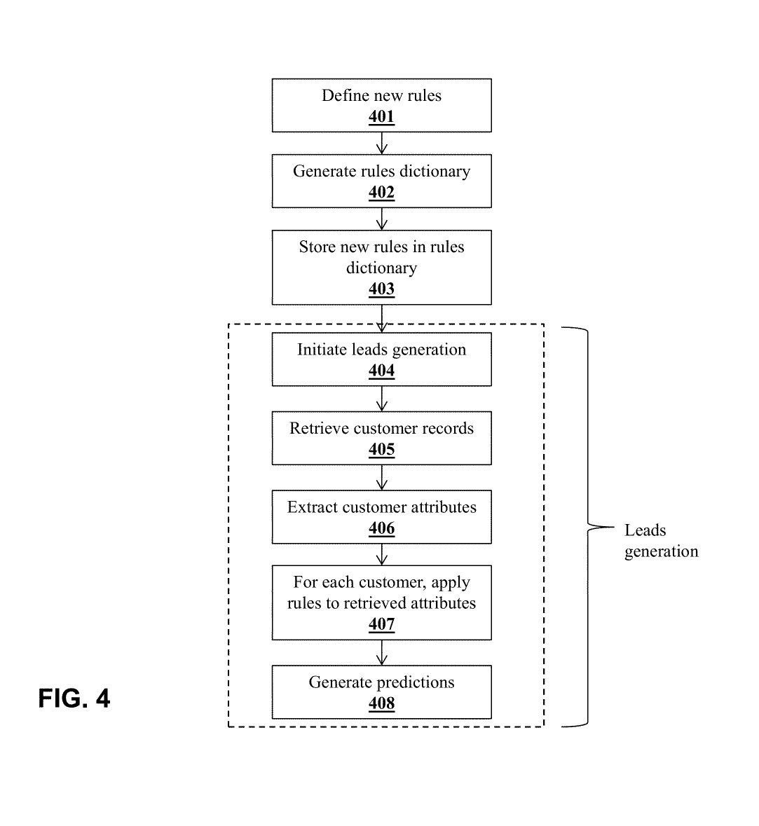

FIG. 4 illustrates a flowchart of a process that may be used to generate rule-based leads in accordance with embodiments of the invention. First, at 401, new rules are defined. The new rules may be defined by a user using the custom rules editor. For example, in some embodiments, there may be one or more drop down menus where the user may select customer attributes recognized by the data model (e.g., location, revenue, and industry) and fields where the user may specify values and relationships that the selected attributes must satisfy in order for a product to be recommended with a certain confidence level. For example, the user may specify a condition wherein the industry attribute of the customer must match the industry code corresponding to “high tech.”

At 402, a rules dictionary containing the data model for the rules is generated. The rules dictionary will contain the RL classes and properties that define the logical data model for the rules. The new rules may then be stored in the rules dictionary at 403, which maps the logical formula entered by the user to the RL classes and properties.

Once the desired rules are defined and stored in the rules dictionary, leads generation may be initiated at 404. In order to initialize leads generation, a user may first specify filters or criteria for the leads generation. For example, a user may wish to only generate recommendations for certain subset of customers (e.g., customers located in North America), or generate recommendations only for a certain product or product family (e.g., only generate recommendations for products in product family A).

Upon initialization of leads generation, customer records and asset data are retrieved at 405. Attributes are extracted from the retrieved data at 406 to form facts. The attributes to be extracted may depend on the rules being evaluated. For example, for a rule that states that Product A will be recommended to customers that are in the “High Tech” industry that have an annual revenue of $5 million or greater, the customer attributes for “industry” and “annual revenue” will be extracted. In some embodiments, attributes that are not used by any of the rules to be processed are not extracted.

At 407, for each customer, the rules from the rules dictionary will be applied to the facts derived from the extracted attributes in order to generate recommendations. At 408, the generated recommendations are output by the system. Generated recommendations from different rules may be aggregated together into a marketing table. In some embodiments, the marketing table containing the generated recommendations may be sorted by customer name, product recommended, or confidence level of the recommendation.

### Runtime Execution Framework

In the rules engine, rules are evaluated in a rule session. A rule session is initialized from a ruleset. Data is then asserted into the rule session and the rules are then executed. The rules may be evaluated on a system server (e.g., an ADF server).

### Lead Generation

Leads are generated on the system server. This generation process may also include evaluation of the eligibility conditions. The batch recommendation job inserts a row into leads staging tables (e.g., MKT_IMP_LEADS_T. and MKT_IMP_LEAD_PRODUCT_T), subject to the constraints defined by the lead generation job. In some embodiments, a separate server (e.g., a SOA server) may be used to apply the order capture eligibility conditions to the rows in the lead/product table before a process is kicked off to import the leads.

There are two flavors of lead generation, namely model-based lead generation and rules-based lead generation.

### Model-Based Lead Generation

For model-based generation, eligibility conditions may be evaluated on a different server (e.g., an ADF server) as the model-based generation. One can either replace the current evaluation of eligibility conditions in the model-based lead generation process in one of four ways:

1) Invoke a web-service from the system server to filter a batch of recommendations for a customer, passing each of the possible recommendations.

2) Invoke a web-service from the batch recommendation job for model-based recommendations just before inserting into the leads staging table, passing each of the possible recommendations.

3) Invoke a web-service from the post processing step of each lead generation thread to update the eligibility of leads inserted into the leads staging table based on the job code.

4) Invoke a web service from the rules eligibility server to evaluate eligibility conditions just prior to invoking the order capture eligibility service, passing the recommendations extracted from the leads staging table and only updating the eligibility flag if either service indicates that a row is false, in batch.

From a functional standpoint, option (1) would be the best because recommendations would be filtered out before the “maximum number of recommendations” is applied. Both option (1) and (2) are advantageous in that they prevent any inserts into the leads staging table when the eligibility conditions do not apply. Option (3) and (4) both yield rows in the leads staging table that would not be there in the current implementation. Options (1), (2), and (4) end up sending all of the recommendations across the wire. It appears that option (3) and (4) provide the best tradeoffs, as there is only a single web service call per lead generation thread. In some embodiments, the system will simply create a rule session pool per thread. Option (4) may easier to implement in embodiments using a SOA server, because SOA is designed for web service calls.

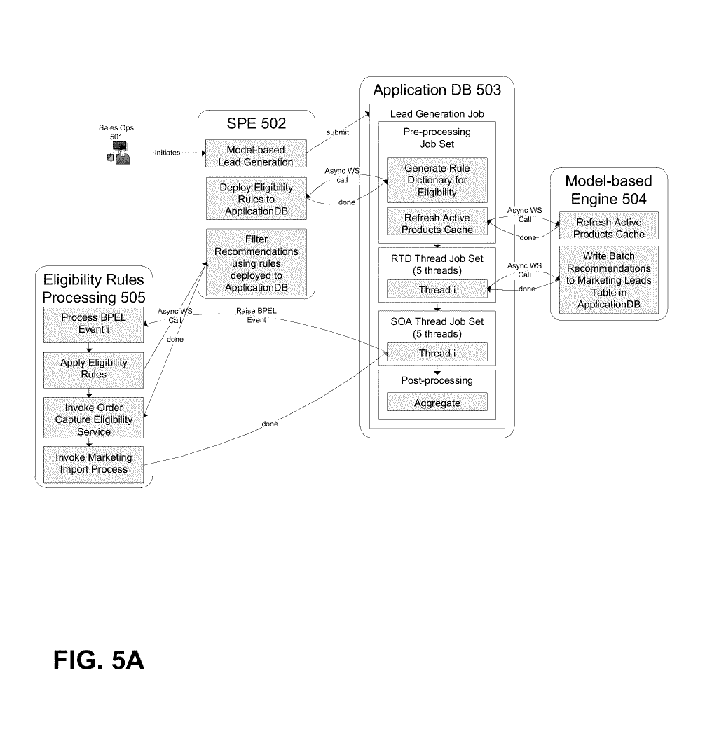

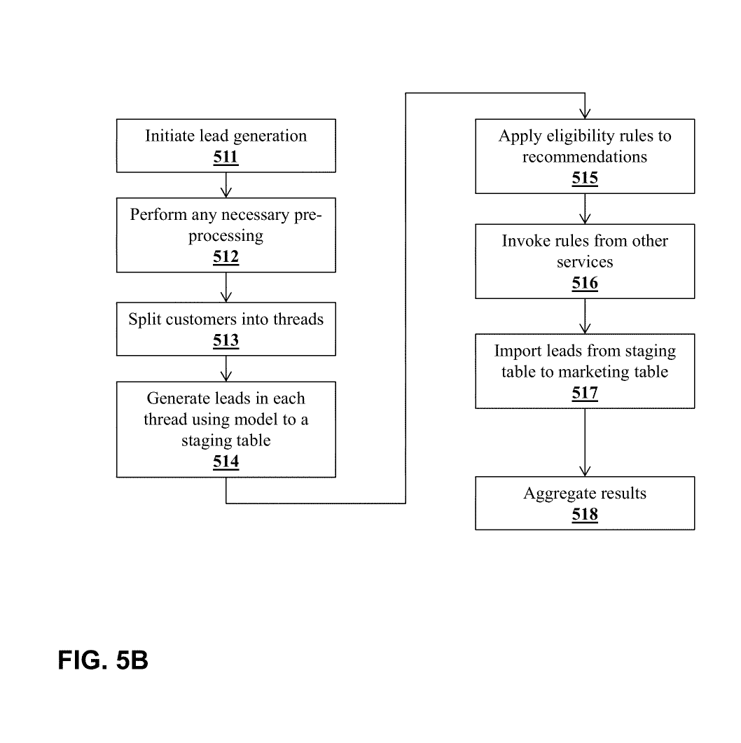

FIG. 5A illustrates an example system for model-based lead generation using option (4) described above. First, a user at user station 501 initiates a model-based lead generation job using the UI at SPE 502. The SPE 502 UI may also be configured to allow the user to provide additional inputs, such as filter conditions for the job. For example, a user may wish to generate leads for North American customers, and so would specify a filter so that only customers with a location attribute of North America will analyzed. In some embodiments, the user may also specify specific products or product families to generate recommendations for. For example, the user may wish to generate sales predictions for product family A for the North American customer base.

The job is submitted by the SPE 502 to Application DB 503. In some embodiments, Application DB 503 invokes a series of four job sets: (1) a pre-processing job set, (2) a model-based job set, (3) an eligibility rules job-set, and (4) a post-processing job set.

During pre-processing, a set of eligibility rules may be specified. Eligibility rules are negative conditions that define eligibility criteria on top of model-based generation that control what kinds of leads may be generated for customers. For example, an eligibility rule may specify that a customer with an industry code corresponding to “agriculture” will not be recommended product A, even though the model may recommend product A based on the customer's other attributes. Other possible eligibility rules may include not recommending a product if the customer already owns the product, if the product is already being worked on for that customer by a sales representative, or if the customer has already rejected the product within a specified time period.

In some embodiments, pre-processing by Application DB 503 may also comprise refreshing the active products cache. The active products cache defines which products are active and can be the subject of the generated leads, predictions, and recommendations. In some embodiments, the products cache is checked against a sales catalog, which stores all products and specifies whether they are active or inactive. If a particular product is not active in the sales catalog, then that product will not be available for generating predictions or recommendations.

In some embodiments, the list of customers may be split into separate threads. For example, if the sales analyst wishes to generate product recommendations for North American customers, and the filtered customer list indicates that there are 1,000 North American customers, the Application DB 503 may split the 1,000 customers into five threads of 200 customers each that can be processed in parallel.

In some embodiments, the model-based job set takes place on a separate model-based engine 504. Each thread is run through the model-based engine 504, where the model is applied to the list of customers in order to generate recommendations. The model-based engine may then write these recommendations into a temporary staging table that is returned to Application DB 503.

After receiving the staging tables from the model-based engine 503, Application DB 503 may send the staging tables containing the leads generated in each thread to eligibility rules processing 505. In some embodiments, eligibility rules processing takes place on a separate server, such as an SOA server.

The eligibility rules from the dictionary are applied to the leads in the staging table. For example, an eligibility rule may specify that customers in a certain industry will not be recommended product A. Therefore, if the model-based engine generated a recommendation of product A for a customer in that industry, the application of the eligibility rule would cause the recommendation to be removed from the staging table.

In some embodiments, additional rules may also be invoked. Other services may define rules at a higher level that are applicable to the sales predictor process. For example, in some embodiments, order capture eligibility rules may be defined by outside separate applications to be applied to the generated leads. These rules may be used to further filter the recommendations in the staging table. In some embodiments, a BPEL (Business Process Execution Language) event may be used to call other services to process the recommendations.

Once the recommendations have been filtered, the remaining recommendations may be moved from the temporary staging table into a marketing table and sent back to Application DB 503. During post-processing, the Application DB 503 aggregates the data from the marketing tables in each thread. In some embodiments, aggregation data based on the returned recommendations may be generated and displayed on the UI, such as total number of leads that have been generated across all threads.

FIG. 5B illustrates a flowchart of a process for model-based lead generation in accordance with embodiments of the invention. First, at 511, leads generation is initialized. Filters on the customers and rules to be processed may be specified at this step.

At 512, pre-processing is performed. In some embodiments, this may include generating a rules dictionary for eligibility rules. Generating a rules dictionary often takes place during pre-processing in embodiments where the job is split into multiple job threads, so that it only needs to happen once, instead of once for each thread. In some embodiments, pre-processing may also include refreshing the active products cache to ensure that recommendations or predictions are only generated for active products.

At 513, the customers may be split into separate threads that may be processed in parallel. This may be useful for large jobs with a high number of customers. In some embodiments, the number of threads the job is split into may be a function of the size of the job. In some embodiments, there may be a minimum or maximum limit on the size of a thread.

At 514, for each thread, the model is applied to the batch of customers in the thread, and recommendations are generated and placed into a staging table. At 515, eligibility rules may be applied to the recommendations in the staging table, filtering out some of the recommendations generated by the model.

At 516, additional eligibility rules generated by other services may be invoked. For example, in some embodiments, additional rules may be generated by an order capture eligibility service. These rules may further filter out generated recommendations from the staging table. At 517, the remaining recommendations in the staging table may be imported into a final marketing table.

At 518, the results from the threads are aggregated. The marketing tables may be combined into a single table. Aggregation data may also be calculated, such as the total number of recommendations generated, and displayed.

### Rule-Based Lead Generation

For rules-based lead generation, both recommendation rules and eligibility conditions are evaluated on the server. Not only does the rules-based lead generation need to generate the leads, but it must do so while respecting the constraints defined by the lead generation process. The lead generation process can limit the number of recommendations for a customer ranked by likelihood to buy, estimated revenue, or estimated sales cycle subject to filters for likelihood to buy, estimated revenue, and estimated sales cycle.

Applying the filters is relatively straightforward in a rules system, but extracting the highest ranked recommendations is not strength of a rules systems. So, the ranking should be done in the integration code that looks at the recommendations and inserts them into the leads staging table (e.g., MKT_IMP_LEAD_PRODUCT_T). For efficiency reasons, the eligibility conditions may be evaluated at the time the rule-based recommendations are generated.

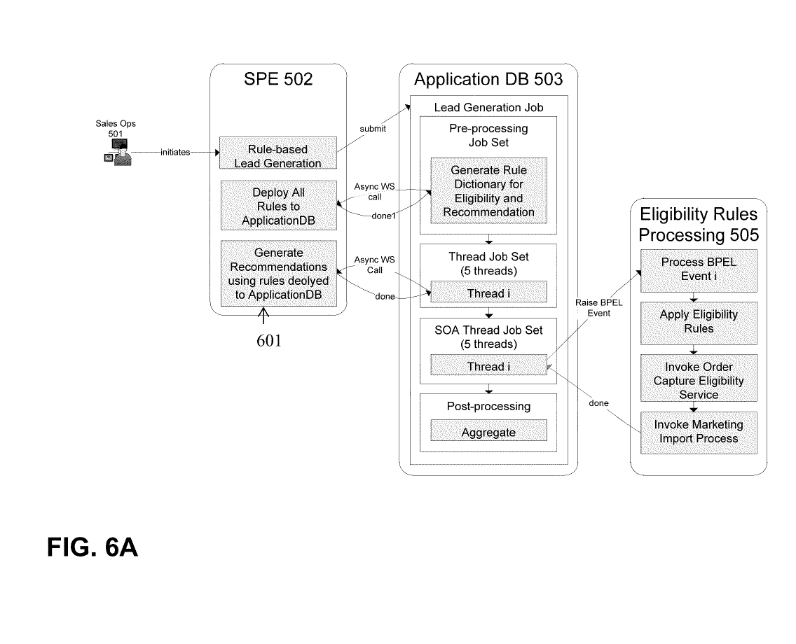

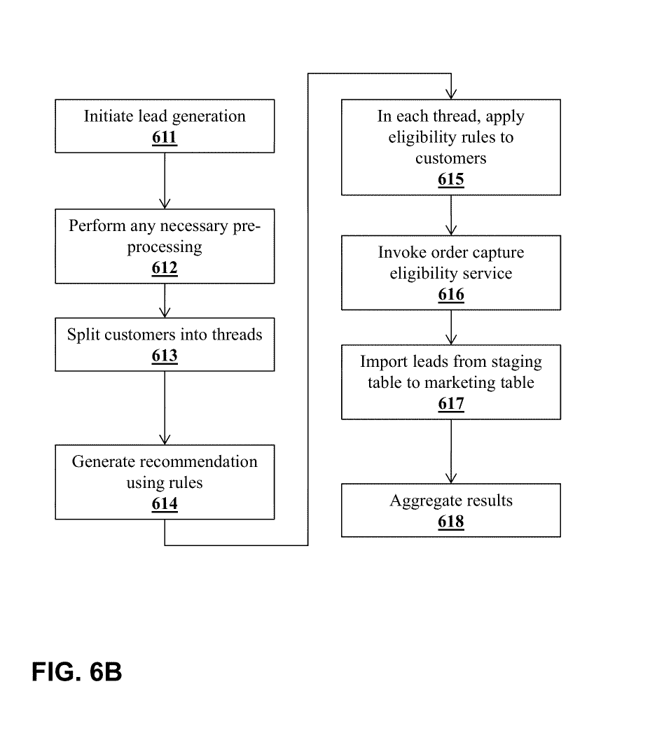

FIG. 6A illustrates an example system for rule-based lead generation. The system is similar to that for generating model-based recommendations, except that recommendation rules are used instead of a model in order to generate recommendations. The user at 501 initiates rule-based lead generation using a UI at SPE 502, specifying desired filter conditions and submitting the job. SPE 502 submits the job to Application DB 503.

Application DB 503 first performs pre-processing. In addition to generating a rules dictionary for eligibility rules, Application DB 503 also generates a rule dictionary for the recommendation rules that will be used to generate the recommendations. At the conclusion of pre-processing, the job may be split into multiple threads to be processed in parallel.

Instead of sending each thread to a model-based engine as in the model-based system, Application DB 503 applies the rules from the recommendation rules dictionary to the batch of customers in each thread in order to generate recommendations at 601. The generated recommendations may be placed in a staging table, which is sent to eligibility rules processing 505.

At eligibility rules processing 505, the eligibility rules from the eligibility rules dictionary are applied to the generated recommendations. The eligibility rules may filter out some of the recommendations generated by the recommendation rules. For example, the recommendation rules may recommend product A to a customer that is in the high tech industry. However, an eligibility rule may state that customers with less than 20 employees are ineligible to be recommended product A. In this case, a customer in the high tech industry but with less than 20 employees may have a recommendation for product A generated by the recommendation rules following rules-based processing, but the recommendation will be filtered out during eligibility rules processing.

In addition to the eligibility rules from the eligibility rules dictionary, additional rules from other services may be applied to the remaining recommendations. Once this is complete, the remaining recommendations may be moved from the staging tables into the final marketing tables, which are returned to the Application DB 503 to be aggregated.

FIG. 6B illustrates a flowchart of a process for rule-based lead generation in accordance with embodiments of the invention. The process is similar to that for model-based lead generation.

First, at 611, leads generation is initialized. Filters on the customers and rules to be processed may be specified at this step. At 612, pre-processing is performed. This includes generating a rules dictionary for both recommendation rules and eligibility rules. In some embodiments, pre-processing may also include refreshing the active products cache to ensure that recommendations or predictions are generated only for active products. At 613, the customers may be split into separate threads that may be processed in parallel. This may be useful for large jobs with a high number of customers.

At 614, for each thread, the recommendation rules are applied to the batch of customers in the thread, resulting in recommendations being generated and placed into a staging table. At 615, eligibility rules may be applied to the recommendations in the staging table. The eligibility rules may filter out some of the recommendations generated by the recommendation rules.

At 616, additional eligibility rules generated by other services may be invoked. For example, in some embodiments, additional rules may be generated by an order capture eligibility service. These rules may further filter out generated recommendations from the staging table.

At 617, the remaining recommendations in the staging table may be imported into a marketing table.

At 618, the results from the threads are aggregated. The marketing tables from each thread may be combined into a single table. Aggregation data may also be calculated, such as the total number of recommendations generated, and displayed.

### Simulation

Simulation can be performed in some embodiments. Simulation results can be ranked by likelihood to buy, estimated revenue, and estimated sales cycle. Like lead generation, simulations can be limited to a fixed number and can be filtered by likelihood to buy, estimated revenue and estimated sales cycle.

In model-based simulation, the system inline service is called to generate the recommendations. The simulation results are filtered on the server after the set of simulation results are generated. Of course, if inline service limits the number of recommendations to a fixed number and the eligibility conditions filter out one or more (and perhaps all) of the simulation results, then the simulation will not show the expected number of results. To alleviate this change in behavior, the simulation web service could be changed to return all of the results and the simulation backing bean could enforce the maximum number of recommendations after the eligibility conditions are enforced.

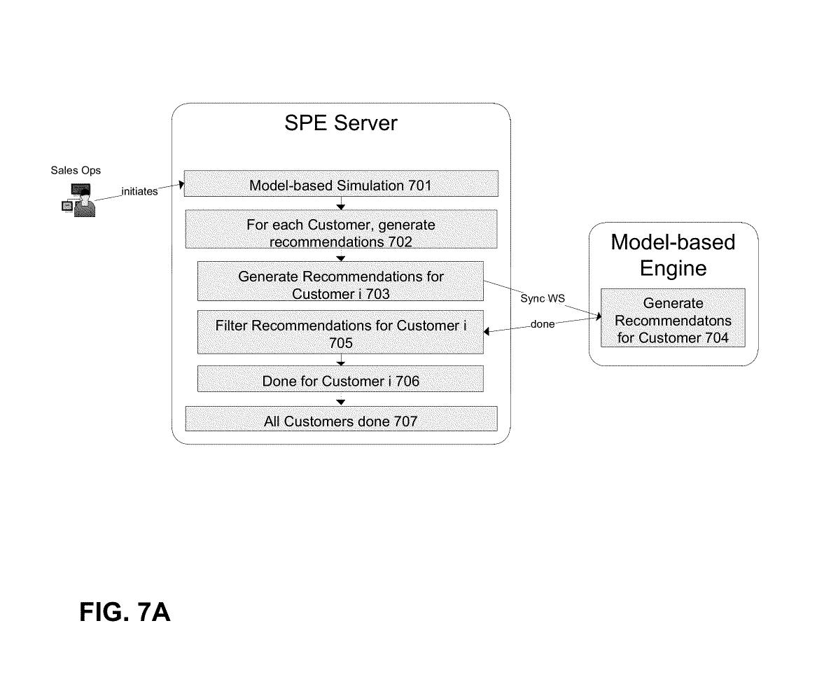

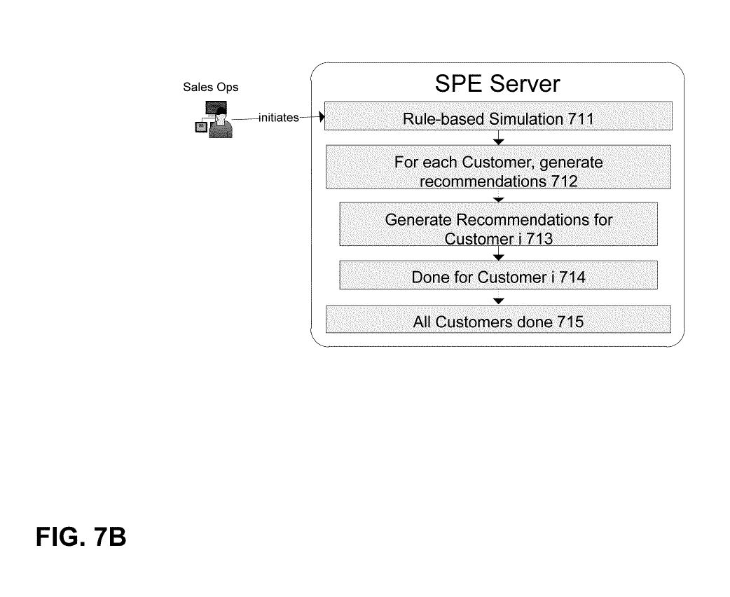

FIG. 7A shows a flow diagram for model-based simulation. At 701, the user initiates model-based simulation. The system at 702 generates recommendations for each customer through 703 through 706.

At 703, the model is applied to the customer to create recommendations for that customer. In some embodiments, this entails sending the data to a separate model-based engine (such an RTD server) at 704. Once recommendations are generated for the customer, eligibility rules may be applied to the generated recommendations at 705 to filter the recommendations. At 706, the system finishes generating recommendations for the customer, and repeats 703 through 705 for each of the remaining customers. Once all customers have been processed, the system may display the simulation results at 707.

In rule-based simulation, each of the sales accounts is processed by the rule system. Both the recommendation rules and the eligibility rules can be evaluated at the same time. Since rules systems are not good at determining the “n” best of something, limiting the number of recommendations will be enforced using procedural code.

FIG. 7B shows a flow diagram for rule-based simulation. At 711, the user initiates rule-based simulation. The system at 712 then loops through each customer to generate recommendations. At 713, recommendation rules and eligibility rules are applied to the customer to generate recommendations. At 714, the system finishes generating recommendations for the customer and moves on to the next customer in the set (repeating 712 through 714). Once all customers have been processed, the system may display the simulation results at 715.

### System Architecture Overview

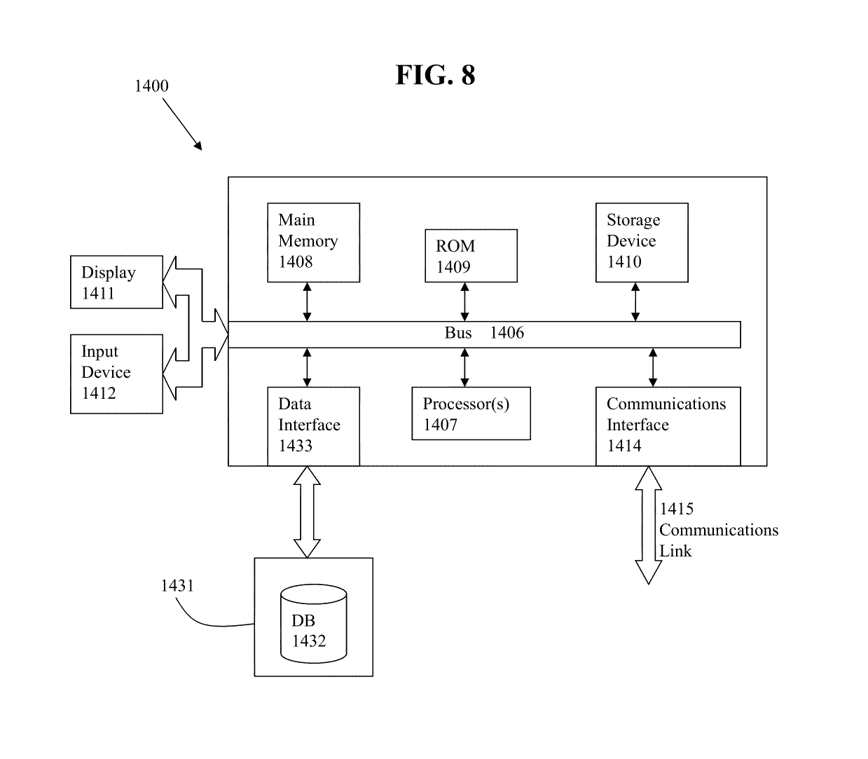

FIG. 8 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1. A method for rule-based sales prediction, comprising:
storing one or more rules in a rules dictionary, wherein the rules dictionary defines a logical data model for the one or more rules;
extracting one or more attributes from one or more entities;
generating one or more predictions of sales corresponding to the one or more entities,
wherein the generating comprises applying the one or more rules to the one or more extracted attributes.

2. The method of claim 1, wherein the one or more rules comprise recommendation rules and eligibility rules.

3. The method of claim 1, wherein the one or more entities comprise customer data or asset data.

4. The method of claim 1, wherein the extracting of one or more attributes is based at least in part upon the one or more rules.

5. The method of claim 1, wherein the one or more predictions comprise data corresponding to a customer name, a recommended product, and a confidence level.

6. The method of claim 1, wherein the one or more predictions are used to generate one or more sales recommendations.

7. The method of claim 1, wherein the rules dictionary maps a rule attribute to an attribute extracted from a customer view object.

8. The method of claim 7, wherein the customer view object is a logical representation of one or more entries of a customer table.

9. The method of claim 1, wherein the generating step further comprises applying one or more models to the extracted attributes.

10. The method of claim 1, further comprising applying one or more eligibility rules to the generated predictions.

11. The method of claim 10, wherein the applying of eligibility rules comprises applying the one or more eligibility rules to one or more extracted attributes of the entities associated with the generated predictions.

12. The method of claim 10, wherein the generated predictions are placed as entries in a staging table, and wherein the eligibility rules are applied to the staging table entries.

13. The method of claim 1, further comprising filtering the one or more entities so that predictions are only generated for specified entities.

14. The method of claim 1, further comprising filtering one or more products so that predictions are only generated for specified products.

15. The method of claim 1, further comprising dividing the one or more entities into one or more job threads.

16. A system for rule-based sales prediction, comprising:
a processor; and
a memory to hold the program code instructions, in which the program code instructions comprises program code to perform: storing one or more rules in a rules dictionary, wherein the rules dictionary defines a logical data model for the one or more rules; extracting one or more attributes from one or more entities; and generating one or more predictions of sales corresponding to the one or more entities; wherein the generating comprises applying the one or more rules to the one or more extracted attributes.

17. The system of claim 16, wherein the one or more rules comprise recommendation rules and eligibility rules.

18. The system of claim 16, wherein the one or more entities comprise customer data or asset data.

19. The system of claim 16, wherein the extracting of one or more attributes is based at least in part upon the one or more rules.

20. The system of claim 16, wherein the one or more predictions comprise data corresponding to a customer name, a recommended product, and a confidence level.

21. The system of claim 16, wherein the one or more predictions are used to generate one or more sales recommendations.

22. The system of claim 16, wherein the rules dictionary maps a rule attribute to an attribute extracted from a customer view object.

23. The system of claim 22, wherein the customer view object is a logical representation of one or more entries of a customer table.

24. The system of claim 16, wherein the generating step further comprises applying one or more models to the extracted attributes.

25. The system of claim 16, further comprising applying one or more eligibility rules to the generated predictions.

26. The system of claim 25, wherein the applying of eligibility rules comprises applying the one or more eligibility rules to one or more extracted attributes of the entities associated with the generated predictions.

27. The system of claim 25, wherein the generated predictions are placed as entries in a staging table, and wherein the eligibility rules are applied to the staging table entries.

28. The system of claim 16, further comprising filtering the one or more entities so that predictions are only generated for specified entities.

29. The system of claim 16, further comprising filtering one or more products so that predictions are only generated for specified products.

30. The system of claim 16, further comprising dividing the one or more entities into one or more job threads.

31. A computer program product including a non-transitory computer readable medium having instructions which, when executed by a processor, causes the processor to perform a process for rule-based sales prediction, the process comprising:
storing one or more rules in a rules dictionary, wherein the rules dictionary defines a logical data model for the one or more rules;
extracting one or more attributes from one or more entities;
generating one or more predictions of sales corresponding to the one or more entities,
wherein the generating comprises applying the one or more rules to the one or more extracted attributes.

32. The computer program product of claim 31, wherein the one or more rules comprise recommendation rules and eligibility rules.

33. The computer program product of claim 31, wherein the one or more entities comprise customer data or asset data.

34. The computer program product of claim 31, wherein the extracting of one or more attributes is based at least in part upon the one or more rules.

35. The computer program product of claim 31, wherein the one or more predictions comprise data corresponding to a customer name, a recommended product, and a confidence level.

36. The computer program product of claim 31, wherein the one or more predictions are used to generate one or more sales recommendations.

37. The computer program product of claim 31, wherein the rules dictionary maps a rule attribute to an attribute extracted from a customer view object.

38. The computer program product of claim 37, wherein the customer view object is a logical representation of one or more entries of a customer table.

39. The computer program product of claim 31, wherein the generating step further comprises applying one or more models to the extracted attributes.

40. The computer program product of claim 31, further comprising applying one or more eligibility rules to the generated predictions.

41. The computer program product of claim 40, wherein the applying of eligibility rules comprises applying the one or more eligibility rules to one or more extracted attributes of the entities associated with the generated predictions.

42. The computer program product of claim 40, wherein the generated predictions are placed as entries in a staging table, and wherein the eligibility rules are applied to the staging table entries.

43. The computer program product of claim 31, further comprising filtering the one or more entities so that predictions are only generated for specified entities.

44. The computer program product of claim 31, further comprising filtering one or more products so that predictions are only generated for specified products.

45. The computer program product of claim 31, further comprising dividing the one or more entities into one or more job threads.
